(19) United States
(12) Patent Application Publication
(10) Pub. No.: US 2024/0012970 A1
(43) Pub. Date: Jan. 11, 2024

(54) OVERSTRESS DESIGN FOR VERIFICATION

(71) Applicants: ATI TECHNOLOGIES ULC, MARKHAM (CA); ADVANCED MICRO DEVICES, INC., Santa Clara, CA (US)

(72) Inventors: David Akselrod, Hamilton (CA); Alexander Kaganov, Toronto (CA); David M. Dahle, Ft. Collins, CO (US); Tyrone Huang, Toronto (CA)

(21) Appl. No.: 17/861,623

(22) Filed: Jul. 11, 2022

(51) Int. Cl. G06F 30/3308

(52) U.S. Cl. CPC G06F 30/3308; G06F 2119/18

(57) ABSTRACT

Techniques for implementing an overstress design for verification that reduce production and verification time by enabling a verification system to perform verification of components of a circuit design selectively, accurately, and exhaustively under extreme stress scenarios are disclosed. Circuit nodes in an emulation model are selected and overstress is provided to the nodes such that behavior of the circuit under such extreme stress scenarios is readily observable, enabling designers to produce circuits that are more secure, reliable, and resilient in case of failures. Overstress is provided to the node to enable verification of the emulation model without having to design complex test signal representations to produce extreme stress conditions. A request for manufacture is generated including aspects of the emulation model to enable verification of a fabricated circuit in a similar or identical manner to those used to verify the emulation model.

### BACKGROUND

Integrated circuit development involves pre-manufacturing verification during which the operation of one or more portions of the integrated circuit are simulated using an electronic design automation simulation tool (e.g., Verilog simulations), as well as emulated, and one or more resulting outputs are compared to a set of expected results. However, verification engineers typically must design complex test signal representations to produce extreme stress conditions in order to ensure that such stresses do not cause unexpected errors or failures, which can cause severe delays in verifying the operation of the integrated circuit and, particularly when verification fails, can severely delay production goals, result in missed deadlines and further manufacturing delays, and otherwise negatively impact the production cycle. Often, after a problem is identified in verification, multiple design teams need to be involved in identifying and remediating the problem, which increases costs and causes further delays. Additionally, even after a problem is remediated, further verification of the entire circuit must be performed to ensure that the remediation of the identified problem does not result in other problems. Accordingly, the verification process typically consumes a large amount of time and resources, especially as integrated circuit designs become more complex and require more security, reliability, and resilience in case of failures.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of an overstress emulation model in accordance with some embodiments.

FIG. 2 is a flow diagram illustrating a method for providing overstress in accordance with some embodiments.

FIG. 3 is a block diagram of a request for manufacture in accordance with some embodiments.

FIG. 4 is a block diagram of an overstress circuit in accordance with some embodiments.

### DETAILED DESCRIPTION

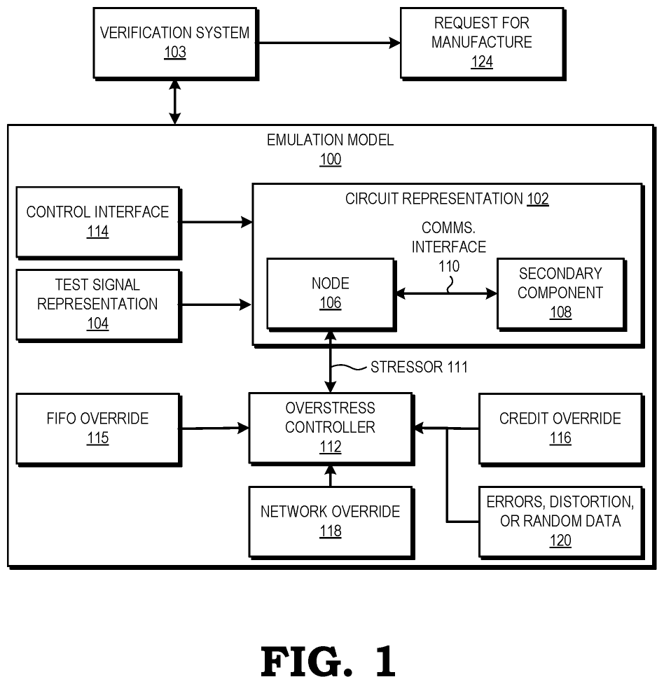

FIGS. 1-4 illustrate techniques for implementing an overstress design for verification that reduces production and verification time by enabling verification of components of a circuit design selectively, accurately, and exhaustively under extreme stress scenarios. In addition to streamlining verification by enabling verification of designs under extreme stress scenarios without necessarily needing to design complex test signal representations, the techniques described herein are, in some embodiments, used to verify operation of a circuit design after fabrication. Thus, rather than having to design complex test signal representations to force a circuit design to enter an overstress condition, which may or may not be possible aspects of the present disclosure allow a circuit to be driven, either prior to (e.g., during simulation and verification) or after fabrication, toward a failure state in order to thoroughly test the circuit's security, reliability, and resilience in the case of such failures. Although aspects of the present disclosure may add nontrivial costs to a fabricated circuit, the time and cost savings resulting from being able to perform efficient verification and troubleshooting will often outweigh the additional costs of fabrication.

To illustrate, in some embodiments, a circuit node in an emulation model is selected and overstress is provided to the node. Designs are often overstressed when extreme stress conditions occur, such as, for example, a buffer indicating it is ready to accept data when it is not or indicating that it is not ready to accept data when, in fact, the buffer is ready to accept data, which can force retry or resend mechanisms to activate. As another example, extreme stress conditions often occur when a component communicating with a bus attempts to transmit more data over the bus than the bus can process in a given time window or, in a network, for example, when a component attempts to transmit too much data over a single route, creating congestion and potentially throttling the network. Generally, extreme stress conditions tend to overstress a design in such a way that one or more components could encounter one or more errors, failures, or faults. By intentionally providing overstress to the node, extreme stress conditions are intentionally introduced to the node to enable verification of the emulation model without necessarily needing to design complex test signal representations that may or may not be able to effect the same conditions. In some embodiments, a request for manufacture is generated including aspects of the emulation model to enable verification of a fabricated circuit in a similar or identical manner to those used to verify the emulation model.

To illustrate further via an example, in some verification scenarios, it is desirable to verify the operation of a module of an integrated circuit design, and in particular the operation of a module as it negotiates a communication session with a secondary component. Conventionally, to verify the operation of the module under an extreme stress scenario, engineers need to invest substantial human and time resources to design the tests, run simulations, and analyze the results of the simulations. For this reason, verification can create undesirable delays in production, particularly when it is difficult or impossible for engineers to design a test signal representation that will reliably cause extreme stresses on particular portions of the chip. However, using the techniques herein, an overstress controller easily implements extreme stress scenarios by providing a stressor to the module to force overstress, e.g., an erroneous condition or intentional backpressure at the module, in such a way that one or more components could reasonably be expected to encounter one or more errors, failures, or faults. Because the overstress controller is usable to override aspects of the module to produce overstress conditions, errors that result from such overstress conditions are more readily identified and accounted for in the design without necessarily needing to design complex test signal representations that may or may not be able to effect the same conditions, which allows the module and other aspects of a circuit containing the module to be developed and adjusted relatively quickly, reducing the time and complexity of the verification process.

Aspects of the present disclosure are directed to pre-manufacture verification, emulation, and on-chip post-fabrication operation and verification. In some embodiments, an overstress design for verification is presented and applied to inter-module, inter-core, inter-chiplet, and/or inter-chip pre-manufacture verification, emulation, or post-fabrication operation or verification. Using aspects of the present disclosure, in some embodiments, overstress applied to a selected node in a circuit results in extreme stress scenarios that are not otherwise easily reproducible. Accordingly, in some embodiments, a more robust, secure, and reliable design can be developed more efficiently and economically.

FIG. 1 illustrates an example of an overstress emulation model 100 implemented in accordance with some embodiments for verifying a circuit such as that stored in a circuit representation 102. In some embodiments, the circuit is stored in the form of a netlist, which is a description of the components and connectivity of an electronic circuit. In some embodiments, the circuit is stored in the form of register-transfer level (RTL), which is a description of the components and connectivity of an electronic circuit. In order to verify expected operation of the circuit representation 102, a verification system 103 under the control of a verification engineer simulates the application of a test signal such as that stored in a test signal representation 104 to one or more nodes, or connection points, of the circuit representation 102 in the emulation model 100. In some embodiments, the verification system 103 is a computing device or test bench including a processor, memory, and input/output interfaces (not shown) that enable a verification engineer to interface with, test, and/or manipulate the emulation model 100. In some embodiments, components of the verification system 103 test operation of fabricated circuits in addition to emulation models. Generally, the verification system 103 includes any hardware or software needed to simulate and verify an emulation model and/or to verify a fabricated circuit in accordance with the present disclosure.

By analyzing output data of the circuit representation 102 that is generated in response to the test signal representation 104 and often other characteristics of the performance of the circuit representation 102 the simulation provides (e.g., thermal characteristics and electromagnetic characteristics, among others), the verification system 103 determines whether the circuit representation 102 accurately performs its intended function. However, modern chip designs often require complex verification tests to ensure that extreme stresses on portions of the chip will not cause unexpected errors or failures. In order to perform such verification tests, engineers often need to invest substantial human and time resources to design the tests, run simulations, and analyze the results of the simulations. For this reason, verification can create undesirable delays in production, particularly when it is difficult or impossible for engineers to design a test signal representation that will reliably cause extreme stresses on particular portions of the chip.

In order to more efficiently perform verification of extreme stress scenarios, in accordance with aspects of the present disclosure, the verification engineer and/or verification system 103 identifies one or more nodes, such as the node 106 of the circuit representation 102, where the node 106 will interface with a secondary component 108, such as a multi-chip module, a communication interface, or any other aspect of a final circuit design, via a communications interface 110 located at the node 106. Although the secondary component 108 is shown in FIG. 1 and described herein as “secondary,” the secondary component 108 represents any component that is not specifically subjected to a particular stress for verification purposes under a given scenario. For example, in some embodiments, the node 106 is a processor or communications channel and the secondary component 108 is a co-processor (such as a graphics processing unit, a machine learning processor, or an application-specific integrated circuit), a cache, or a second communications channel, such as a bus. As another example, in some embodiments, the node 106 is a cache, a first-in, first-out (FIFO) circuit or an interface with a FIFO circuit, a router, or a switch, such as in a network-on-chip (NOC), and the secondary component 108 represents any one or more of a number of devices connected with the node 106. Accordingly, in some embodiments, the communications interface 110 is an intra-die, inter-die, stack-to-stack, bus-to-bus, or socket-to-socket interface that connects the node 106 with one or more other representations of multi-chip modules, chiplets, cores, modules, or other components. Thus, in some embodiments, a final circuit design includes the circuit of circuit representation 102, including the node 106, the secondary component 108, and the communications interface 110.

After selecting a node such as the node 106 in the circuit representation 102 connected to a secondary component such as the secondary component 108 through an interface such as the communications interface 110, the verification system 103 uses aspects of the present disclosure in order to simulate performance of the circuit representation 102 under scenarios that produce extreme stresses on the circuit of the circuit representation 102 and/or the node 106 to ensure that such stresses do not cause unexpected errors or failures. In order to apply overstress to the circuit of circuit representation 102 at the node 106, the present disclosure provides a stressor 111 to the node 106 in accordance with an overstress controller 112 configured to intentionally push the circuit and/or the node 106 close to or beyond a point of failure. For example, in some embodiments, the stressor 111 is specifically designed to overstress a design to effect an extreme stress condition, e.g., an erroneous condition or intentional backpressure at the module, in such a way that one or more components could reasonably be expected to encounter one or more errors, failures, or faults. For example, in some embodiments, the stressor 111 is a signal, or a set of inputs, that causes a design to exceed or otherwise violate a specified minimum, maximum, or tolerance of a design. In some embodiments, the stressor 111 provides faulty information to the node 106 to force it to enter an extreme stress condition, and in other embodiments, the stressor 111 overrides or overwrites a register or buffer associated with the node 106 to force the node 106 and/or one or more components communicatively coupled or otherwise associated with the node 106 to enter an extreme stress condition.

In order to enable the verification system 103 to generate the stressor 111 using the overstress controller 112, in some embodiments, the emulation model 100 includes a control interface 114 usable to control operation of the overstress controller. In some embodiments, the control interface 114 is external to the circuit representation 102, as shown in FIG. 1, but in other embodiments the control interface 114 is wholly or partially included in the circuit representation 102. Generally, the control interface 114 enables the verification system 103 to enable or disable (bypass) overstress at desired nodes, such as the node 106, and/or to configure the associated overstress controller 112 to provide an appropriate stressor 111.

In some embodiments, the verification system 103 configures the overstress controller 112 to provide a FIFO override 115 to the node 106 via stressor 111. The FIFO override 115 enables the verification system 103 to introduce artificial backpressure, for example, through a FIFO (such as a voltage domain crossing interface FIFO in an asynchronous clock crossing scenario) associated with or at the node 106 in order to simulate an overstress scenario at the node 106. In some embodiments, the stressor 111 overrides a control signal indicating that the FIFO at the node 106 is ready to accept new data in order to either cause the FIFO to erroneously indicate that it is not ready to accept new data (e.g., prematurely, when the FIFO is in fact ready to accept new data) or to erroneously indicate that it is ready to accept data (e.g., when the FIFO is not in fact ready to accept new data). By overriding a control signal indicating that the FIFO at the node 106 is ready to accept new data via the stressor 111, the overstress controller 112 applies artificial limitations or errors to the circuit in circuit representation 102, which enables the verification system 103 to simulate extreme conditions without an engineer necessarily needing to design complex test signal representations 104 that may or may not be able to effect the same conditions.

In some embodiments, the verification system 103 configures the overstress controller 112 to provide a credit override 116 to the node 106 via stressor 111. The credit override 116 enables the verification system 103 to introduce artificial flow control stress, for example, in a bus at or associated with the node 106. In normal operation, in some embodiments, a portion of a bus, such as a physical or virtual channel or interface, maintains a credit counter indicating a capacity for receiving data at a receiver (e.g., secondary component 108), decrements the counter after transmitting data to the receiver, and increments the counter when the receiver provides an indication that the receiver has processed or otherwise consumed the data (e.g., a packet in a buffer). In some embodiments, the credit counter is a Boolean “on/off” indication (effectively a single-credit counter) indicating whether the receiver is ready for new data, which may be based on a high and/or low buffer occupancy level (such as a watermark) at the receiver. In some embodiments, the credit counter may include a conversion or weight to account for differences in capacity between two channels (e.g., between the node 106 and the secondary component 108). However, in some embodiments, the credit override 116 causes the overstress controller 112 to provide the stressor 111 to the node 106 in order to override the number of credits or the credit conversion to intentionally overstress the circuit of circuit representation 102.

For example, in some embodiments, the credit override 116 causes a component at the node 106 to erroneously receive an indication via the stressor 111 that a receiver such as the secondary component 108 has processed or otherwise consumed data that is has not in fact processed or consumed such that the component at the node 106 attempts to send more data when the receiver is not ready to receive new data. In some embodiments, the credit override 116 causes a credit conversion associated with a credit counter to function erroneously via the stressor 111 to produce similar results, causing the component at the node 106 to attempt to send new data when a receiver such as secondary component 108 is not ready to accept new data. Similarly, in some embodiments, the credit override 116 causes the credit counter or credit override to indicate that a receiver such as secondary component 108 is not ready for new data when it is, in fact, ready to receive new data. As with the FIFO override 115, by overriding a credit counter or credit conversion in this way via the stressor 111, the overstress controller 112 applies artificial limitations or errors to the circuit in circuit representation 102, which enables the verification system 103 to simulate extreme conditions without an engineer necessarily needing to design complex test signal representations 104 that may or may not be able to effect the same conditions.

In some embodiments, the verification system 103 configures the overstress controller 112 to provide a network override 118 to the node 106 via stressor 111. The network override 118 enables the verification system 103 to introduce artificial flow control stress, for example, in a bus, NOC, switch, or router at or associated with the node 106. In order to overstress the circuit of the circuit representation 102 at the node 106, in some embodiments, the network override 118 injects errors at the node 106 via the stressor 111 in order to cause, for example, improper hops, forwarding, or other routing decisions, improper buffer-full statuses, deadlocks, packet drops, higher or lower latencies than expected during normal operation, scheduling errors, internal buffer limit errors, routing control errors, and/or packet time-to-live errors, among others. For example, in some embodiments, by overwriting a buffer limit at the node 106, the stressor 111 forces retry or resend mechanisms to activate based on the network override 118. In some embodiments, by overwriting a routing tree, all packets are forced to take a single route, resulting in congestion at a single location. In some embodiments, disabling a packet time-to-live mechanism while flooding the communications interface 110 with packets creates an excess number of packets in order to throttle the network. Thus, similarly to the FIFO override 115 and credit override 116, by overriding a network condition in this way via the stressor 111 based on the network override 118, the overstress controller 112 applies artificial limitations or errors to the circuit in circuit representation 102, which enables the verification system 103 to simulate extreme conditions without an engineer necessarily needing to design complex test signal representations 104 that may or may not be able to effect the same conditions.

In some embodiments, the verification system 103 configures the overstress controller 112 to produce other errors, distortion, and/or random data 120 at the node 106 via the stressor 111 as required to ensure the robustness of the circuit of circuit representation 102. Thus, in some embodiments, the verification system 103 configures the overstress controller 112 to cause parity errors, introduce data distortions in re-transmission of data, override pool credit allocations or priorities, simulate peak current control or voltage droop errors, and/or simulate packet or transmission drops or errors, among others, at the node 106 in order to provide exhaustive verification and, as a result, increase the security or reliability of a circuit of the circuit representation 102 by enabling engineers to account for such situations in the design of the circuit of circuit representation 102. In some embodiments, the verification system 103 configures the overstress controller 112 to respond to programmable triggers based on an output of the circuit in circuit representation 102 at node 106, in some embodiments such that the overstress controller 112 only provides a stressor 111 in response to the triggers while the overstress controller 112 is otherwise bypassed or merely inactive.

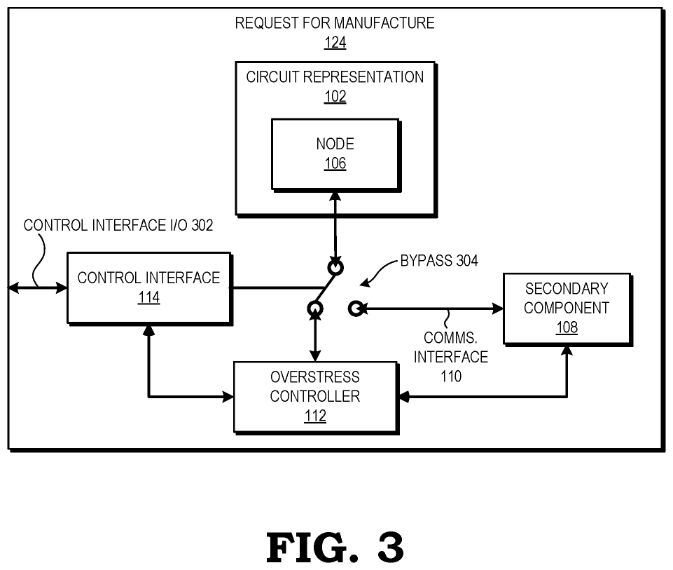

Accordingly, using aspects of the present disclosure, the verification system 103 configures the overstress controller 112 as needed via the control interface 114 in order to provide the stressor 111 at the node 106 when required, which enables the verification system 103 to simulate operation of the circuit in circuit representation 102 in extreme stress scenarios without necessarily needing to design complex test signal representations 104 that may or may not be able to effect the same conditions. After a final circuit design is complete and the verification system 103 executes all required simulations and verifies that the circuit in circuit representation 102 performs as expected under extreme stress scenarios without producing unexpected errors or failures, in some embodiments, at block 212, the verification engineer and/or verification system 103 then includes the overstress controller 112 in a request for manufacture 124, as described further herein in connection with FIG. 3. Typically, the request for manufacture 124 is a digital file or set of files that a manufacturer uses to fabricate the circuit of circuit representation 102, although the request for manufacture 124 can take any form provided that a manufacturer can use it to fabricate the desired product.

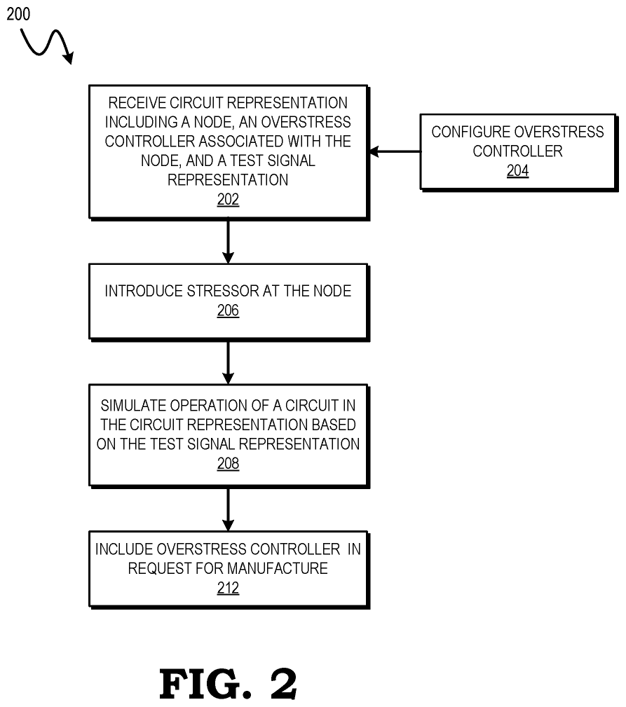

FIG. 2 illustrates an example method 200 for providing overstress in accordance with some embodiments. At block 202, a verification system such as the verification system 103 of FIG. 1 receives a circuit representation comprising a node, an overstress controller associated with the node, and a test signal representation. As discussed above with reference to FIG. 1, a verification engineer and/or the verification system 103 provides the circuit representation 102 and associates the overstress controller 112 with a node 106 of the circuit representation 102 in order to test operation of the circuit of the circuit representation 102 under extreme stress scenarios. In some embodiments, the verification engineer and/or the verification system 103 selects or designs a specific test signal representation 104 in order to verify operation of the circuit in the circuit representation 102. In some embodiments, at block 204, as discussed above, the verification engineer and/or the verification system 103 also configures the overstress controller 112 to provide the desired stressor 111. However, in other embodiments, the overstress controller 112 is preconfigured for testing a particular circuit in the circuit representation 102.

At block 206, the verification system introduces a stressor, such as the stressor 111, at a node such as node 106 of the circuit of the circuit representation 102. As discussed above, the stressor 111 variously causes one or more overstresses in the circuit of the circuit representation 102 in order to test extreme stress scenarios that otherwise may or may not be effected using a test signal representation alone. At block 208, the verification engineer causes the verification system 103 to simulate operation of the circuit in the circuit representation 102 based on the test signal representation 104 and the stressor 111. In some embodiments, the circuit of circuit representation 102 is redesigned and resimulated in order to eliminate any errors or failures detected during simulation. After completing all required simulations and verifying that the circuit in circuit representation 102 performs as expected, in some embodiments, at block 212, the verification engineer and/or verification system 103 then includes the overstress controller 112 in a request for manufacture such as request for manufacture 124 of FIG. 1. In some embodiments, one or more portions of method 200 are automated, preconfigured, loaded, executed, or scripted as a function of instructions stored on a non-transitory computer readable medium or otherwise performed using automation.

FIG. 3 illustrates an example request for manufacture 124 in accordance with some embodiments. As discussed above, using aspects of the present disclosure, a verification engineer verifies circuit representations such as circuit representation 102 of FIG. 1 using a verification system such as verification system 103 of FIG. 1. However, using aspects of the present disclosure, in some embodiments, even after fabrication of a circuit, such as the circuit of circuit representation 102, the verification engineer and/or the verification system 103 uses the same or similar aspects of the present disclosure to verify the actual operation of a circuit, such as the circuit of circuit representation 102, by including components such as one or more components of the emulation model 100 of FIG. 1 in a request for manufacture, such as the request for manufacture 124 of FIG. 3. For example, as shown in FIG. 3, in some embodiments, such a request for manufacture includes the circuit of circuit representation 102, the node 106, the secondary component 108, the communications interface 110, the overstress controller 112, and the control interface 114. Additionally, in the example of FIG. 3, the request for manufacture 124 includes a control interface input/output 302 (such as a port, a pin, or a communications module) and a bypass switch 304. In some embodiments, only one of the overstress controller 112 and the bypass switch 304 are included in a request for manufacture. In some embodiments, these additional components and/or other components are also included in the emulation model 100 of FIG. 1. As discussed above, the verification system 103 accesses the control interface 114 to control the overstress controller 112, and thus to control the stressor 111 (FIG. 1) that the overstress controller 112 will provide to the node 106.

In some embodiments, the control interface input/output 302 is a pin operable to control bypass switch 304, in which case the control interface 114 and control interface input/output 302 are a single component. In other embodiments, the control interface input/output 302 is a port, a pin, or a communications module through which the verification system 103 can provide more complex signals and/or instructions to the overstress controller 112 in addition to controlling the bypass switch 304. For example, in some embodiments, the control interface 114 is a wireless interface and the control interface input/output 302 is an antenna, enabling the verification system 103 to wirelessly interact with the control interface 114. Generally, the control interface 114 and control interface input/output 302 can take any form that enables the verification system 103 to interact with the overstress controller 112 and/or bypass switch 304 as needed.

In some embodiments, the bypass switch 304 is controllably actuated through the control interface 114 and/or the overstress controller 112 in order to provide overstress in the form of a stressor 111 in accordance with the teachings of the present disclosure. Although shown as a switch in FIG. 3, in some embodiments, the bypass switch 304 is a multiplexer or any other suitable switching element. In some embodiments, the verification system 103 manually controls the bypass switch 304 by interacting with the control interface 114. In some embodiments, the verification system 103 configures the overstress controller 112, either in the details of the request for manufacture 124 or, after fabrication of, e.g., an integrated circuit in accordance with the request for manufacture 124, through control interface 114, to control the bypass switch 304. Thus, the bypass switch 304 is selectively controllable to, e.g., provide overstress via overstress controller 112 to enable a verification system to verify the operation of the circuit of circuit representation 102 under extreme conditions, and then to bypass the overstress controller 112 and connect the node 106 of the circuit of circuit representation 102 directly to the secondary component 108 via the communications interface 110 to enable normal operation of the circuit of circuit representation 102 after verification is complete.

An additional advantage of including the overstress controller 112, the control interface 114, the control interface input/output 302, and the bypass switch 304 in a request for manufacture such as request for manufacture 124 is that even after verification is complete and the bypass switch 304 has been switched to connect the node 106 of the circuit of circuit representation 102 with the secondary component 108 via the communications interface 110, the bypass switch 304 can be still be reverted. For example, if unexpected problems arise in the operation of the circuit of circuit representation 102 in normal operation (e.g., end-user use), a device containing the circuit can be returned to the manufacturer, and the manufacturer can more easily diagnose any problems that may be caused by the circuit in circuit representation 102 using techniques described hereinabove. Thus, in some embodiments, repair or diagnostic technicians use aspects of the present disclosure to diagnose potential problems in fabricated circuitry after it has been incorporated into a device and sold.

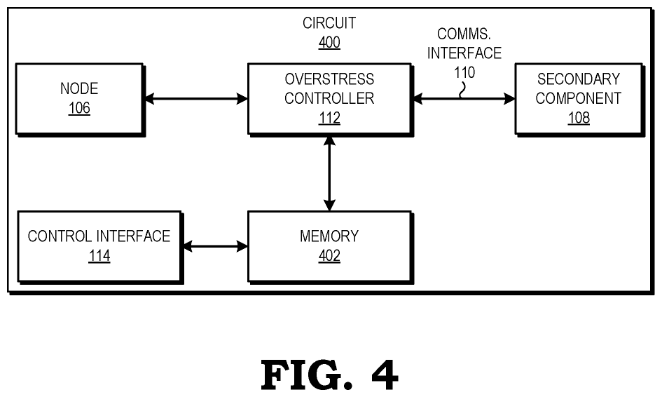

FIG. 4 illustrates an example overstress circuit in accordance with some embodiments. In some embodiments, the overstress circuit 400 is fabricated based on the request for manufacture 124 of FIG. 1. In the overstress circuit 400, the node 106, the secondary component 108, the communications interface 110, the overstress controller 112, and the control interface 114 are similar to those described above in connection with FIG. 1, although they are arranged differently in FIG. 4. For example, in circuit 400, the overstress controller 112 is interposed between the node 106 of the circuit 400 and the secondary component 108 along communications interface 110. Using this configuration, the overstress controller 112 either provides overstress to the node 106 or, when selectively bypassed, allows signals from the node 106 to travel directly to the secondary component 108 via the communications interface 110. As discussed above, the control interface 114 enables a verification system such as the verification system 103 of FIG. 1 to enable or disable (bypass) overstress at desired nodes, such as the node 106, and/or to configure the associated overstress controller 112 to provide an appropriate stressor.

In order to configure the overstress controller 112 of the circuit 400, in some embodiments, a verification system programs a memory 402 connected with the overstress controller 112. In FIG. 4, the memory 402 is shown separately from the overstress controller 112, although in some embodiments the overstress controller 112 contains the memory 402. In some embodiments, the memory 402 is programmable and contains instructions or data for controlling the overstress controller 112 provided via the control interface 114. In other embodiments, the memory 402 is preprogrammed such that control interface 114 is omitted from the circuit 400. When the control interface 114 is omitted, in some embodiments, the overstress controller 112 is activated based on predetermined signals from the node 106 or a predetermined operation of the circuit 400. For example, in some embodiments, the circuit 400 enters a test mode that activates the overstress controller 112 to selectively provide overstress to the node 106 in response to, e.g., a diagnostic signal received from the node 106 or an unexpected power cycle of the circuit 400. In some embodiments, the overstress controller 112 provides overstress to the node 106 for a set period of time after the circuit 400 is powered on to enable an initial diagnostic phase of a device containing the circuit 400, after which the overstress controller 112 automatically reverts to a bypass mode, enabling normal operation of the circuit 400 without overstress. Thus, the overstress controller 112 is enabled or disabled (bypassed) depending on desired functionality and, in some embodiments, for a preconfigured period of time.

In some embodiments, the techniques described above are implemented in a system including one or more integrated circuit (IC) devices (also referred to as integrated circuit packages or microchips), such as the overstress emulation model 100, the method 200 for providing overstress, the request for manufacture 124, and the overstress circuit 400 described above with reference to FIGS. 1-4. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving a circuit representation comprising a node and an overstress controller associated with the node;
providing a stressor to the circuit representation at the node via the overstress controller; and
simulating operation of a circuit in the circuit representation.

2. The method of claim 1, wherein the node is located at a communications interface of the circuit representation.

3. The method of claim 2, wherein the communications interface is an intra-die, inter-die, stack-to-stack, or socket-to-socket interface.

4. The method of claim 1, wherein the stressor is provided by the overstress controller, the method further comprising configuring the overstress controller to control the stressor.

5. The method of claim 4, wherein configuring the overstress controller comprises configuring the overstress controller to produce a FIFO override.

6. The method of claim 4, wherein configuring the overstress controller comprises configuring the overstress controller to produce a network or credit override.

7. The method of claim 4, wherein configuring the overstress controller comprises configuring the overstress controller to produce errors, distortions, or random data in the stressor.

8. The method of claim 4, wherein the circuit representation includes a control interface operable to configure the overstress controller, the method further comprising including the overstress controller and the control interface in a request for manufacture of the circuit representation.

9. The method of claim 8, wherein the control interface is operable to selectively bypass the overstress controller.

10. The method of claim 1, further comprising including the overstress controller in a request for manufacture of the circuit representation.

11. A non-transitory computer readable medium embodying a set of executable instructions, the set of executable instructions to manipulate at least one processor to:
receive a circuit representation comprising a node and an overstress controller associated with the node;
provide a stressor to the circuit representation at the node via the overstress controller; and
simulate operation of a circuit in the circuit representation.

12. The non-transitory computer readable medium of claim 11, wherein the node is located at a communications interface of the circuit representation.

13. The non-transitory computer readable medium of claim 12, wherein the communications interface is an intra-die, inter-die, stack-to-stack, or socket-to-socket interface.

14. The non-transitory computer readable medium of claim 11, wherein the stressor is provided by the overstress controller, the instructions further comprising instructions for configuring the overstress controller to control the stressor.

15. The non-transitory computer readable medium of claim 14, wherein the instructions for configuring the overstress controller comprise instructions for configuring the overstress controller to produce a FIFO override.

16. The non-transitory computer readable medium of claim 14, wherein the instructions for configuring the overstress controller comprise instructions for configuring the overstress controller to produce a network or credit override.

17. The non-transitory computer readable medium of claim 14, wherein the circuit representation includes a control interface operable to configure the overstress controller, the instructions further comprising instructions for including the overstress controller and the control interface in a request for manufacture of the circuit representation.

18. The non-transitory computer readable medium of claim 17, wherein the control interface is operable to selectively bypass the overstress controller.

19. The non-transitory computer readable medium of claim 11, wherein the instructions further comprise instructions for including the overstress controller in a request for manufacture of the circuit representation.

20. An emulation model comprising:
a circuit representation comprising a node; and
an overstress controller associated with the node of the circuit representation,
wherein the overstress controller is configured to provide a stressor to the circuit representation at the node.
